(19) United States
(12) Patent Application Publication
(10) Pub. No.: US 2025/0316853 A1
(43) Pub. Date: Oct. 9, 2025

(54) BATTERY PACK

(71) Applicants: Hyundai Motor Company, Seoul (KR); Kia Corporation, Seoul (KR)

(72) Inventors: Mee Sun Oh, Hwaseong-si (KR); Seung Heo, Gwacheon-si (KR); Chae Eun Lee, Seoul (KR); Seok Jun Bang, Incheon (KR)

(21) Appl. No.: 18/960,767

(22) Filed: Nov. 26, 2024

(30) Foreign Application Priority Data
Apr. 9, 2024 (KR) 10-2024-0047931

(51) Int. Cl. H01M 50/507; H01M 10/42; H01M 50/204; H01M 50/242; H01M 50/258; H01M 50/271; H01M 50/503; H01M 50/588

(52) U.S. Cl. CPC H01M 50/507; H01M 10/425; H01M 50/204; H01M 50/242; H01M 50/258; H01M 50/271; H01M 50/503; H01M 50/588; H01M 2220/20

(57) ABSTRACT

An embodiment battery pack includes a case having an internal space in which a plurality of battery modules arranged in front-rear and left-right directions is placed, a plurality of transverse members disposed between the battery modules arranged in the front-rear direction among the plurality of battery modules, a plurality of transverse bus bars disposed in internal spaces of the transverse members and configured to connect the battery modules arranged in the front-rear direction, a longitudinal member disposed between the battery modules arranged in the left-right direction among the plurality of battery modules and extending in the front-rear direction, and a pair of longitudinal bus bars disposed in an internal space of the longitudinal member, extending in the front-rear direction, and configured to connect a first component disposed forward of the battery modules to a second component disposed rearward of the battery modules.

### CROSS-REFERENCE TO RELATED APPLICATIONS

This application claims the benefit of Korean Patent Application No. 10-2024-0047931, filed on Apr. 9, 2024, which application is hereby incorporated herein by reference.

### TECHNICAL FIELD

The present disclosure relates to a battery pack.

### BACKGROUND

Generally, a battery pack mounted in a vehicle has a structure in which a plurality of battery modules is stored within a case, and the plurality of battery modules is electrically interconnected through a bus bar.

Moreover, the battery pack is provided with a power relay assembly (PRA) configured to supply or block power to charge or discharge the battery, and the PRA is provided inside the case of the battery pack.

The PRA may be disposed rearward of the plurality of battery modules due to space constraints within the case. Here, so as to connect the PRA to a component (e.g., a connector) disposed forward of the plurality of battery modules, provided is a pair of bus bars extending longitudinally across the battery pack.

Here, the plurality of bus bars provided within the case is arranged in a predetermined direction due to spatial constraints within the case having a limited space. Therefore, the plurality of bus bars having different polarities from each other has a risk of being short-circuited in the event of vibration or collision on the vehicle or thermal runaway of the battery module.

Furthermore, when a short circuit occurs between the bus bars having different polarities from each other, a fire may occur in the relevant battery module, and in this case, there is a risk that the flame may spread to a battery module that has not caught fire.

The above information disclosed in this background section is only for enhancement of understanding of the background of embodiments of the present disclosure, and therefore it may contain information that does not form the already known prior art.

### SUMMARY

The present disclosure relates to a battery pack. Particular embodiments relate to a battery pack capable of preventing flames from some battery modules within a case from spreading to other battery modules.

Embodiments of the present disclosure have been made in an effort to solve problems associated with the prior art, and a particular embodiment of the present disclosure provides a battery pack configured to have an independent compartment structure for each battery module within a case, whereby, even if a fire occurs in some battery modules, the flame is prevented from spreading to surrounding battery modules.

The embodiments of the present disclosure are not limited to the foregoing, and other embodiments not mentioned herein will be clearly understood by those of ordinary skill in the art to which the present disclosure pertains based on the description below.

One embodiment of the present disclosure provides a battery pack including a case having an internal space in which a plurality of battery modules arranged in front-rear and left-right directions is placed, a plurality of transverse members disposed between battery modules arranged in a front-rear direction among the plurality of battery modules, a plurality of transverse bus bars each placed in internal spaces of the transverse members and configured to interconnect the battery modules arranged in the front-rear direction, a longitudinal member provided between battery modules arranged in a left-right direction among the plurality of battery modules and extending in the front-rear direction, and a pair of longitudinal bus bars placed in an internal space of the longitudinal member and extending in the front-rear direction and configured to connect a first component disposed forward of the battery modules to a second component disposed rearward of the battery modules.

In an embodiment, the case may have an upper end at which a cover is provided, and the cover may cover the upper end of the case while being in close contact with the upper end of the case, the upper end of the longitudinal member, and the upper ends of the transverse members.

In another embodiment, the upper end of the longitudinal member and the upper ends of the transverse members may be disposed at the same height as the upper end of the case.

In still another embodiment, the plurality of transverse members may include a first end portion adjacent to the longitudinal member and a second end portion adjacent to the case.

In yet another embodiment, the longitudinal member may include a first end portion extending up to a position of a first transverse member disposed at the most forward position among the plurality of transverse members and a second end portion extending up to a position of a second transverse member disposed at the rearmost position among the plurality of transverse members.

In still yet another embodiment, the plurality of battery modules each may be provided with a first terminal connected to a transverse bus bar disposed at the front of the battery module and a second terminal connected to a transverse bus bar disposed at the rear of the battery module.

In a further embodiment, the longitudinal member may have a storage space in which the pair of longitudinal bus bars is placed, and the storage space is filled with an insulating material.

In another further embodiment, the plurality of transverse members each may have a storage space in which one transverse bus bar is placed.

In still another further embodiment, the upper end of the case, the upper end of the longitudinal member, and the upper ends of the transverse members may be attached to the bottom surface of the cover through a sealer.

In yet another further embodiment, the first component may be a pair of power relay assemblies (PRAs), and the second component may be a first connector. Here, the pair of PRAs may be connected to a second connector disposed opposite the first connector with respect to the pair of longitudinal bus bars.

Another embodiment of the present disclosure provides a battery pack including a case having an internal space in which a plurality of battery modules arranged in front-rear and left-right directions is placed, a plurality of transverse members disposed between battery modules arranged in a front-rear direction among the plurality of battery modules, a plurality of transverse bus bars each placed in internal spaces of the transverse members and configured to interconnect the battery modules arranged in the front-rear direction, a longitudinal member provided between battery modules arranged in a left-right direction among the plurality of battery modules and extending in the front-rear direction, and a cover configured to cover the upper end of the case while being in close contact with the upper end of the case, the upper end of the longitudinal member, and the upper ends of the transverse members.

Other aspects and embodiments of the present disclosure are discussed infra.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of embodiments of the present disclosure are discussed infra.

### BRIEF DESCRIPTION OF THE DRAWINGS

The above and other features of embodiments of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a perspective view illustrating a battery pack according to an embodiment of the present disclosure;

FIG. 2 is a plan view illustrating a battery pack, with a cover removed, according to an embodiment of the present disclosure;

FIG. 3 is a cross-sectional view taken along line A-A in FIG. 1;

FIG. 4 is a cross-sectional view taken along line B-B in FIG. 1; and

FIG. 5 to FIG. 7 are views each illustrating a cutaway portion of a battery pack, with a cover removed, according to an embodiment of the present disclosure.

It should be understood that the appended drawings are not necessarily to scale, presenting a somewhat simplified representation of various features illustrative of the basic principles of embodiments of the present disclosure. The specific design features of embodiments of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION OF ILLUSTRATIVE EMBODIMENTS

Hereinafter, embodiments of the present disclosure will be described with reference to the accompanying drawings. The matters described in the attached drawings may be different from those actually implemented in order to facilitate description of the embodiments of the present disclosure.

In this specification, the terms “first,” “second,” etc. may be used to describe various components, but the components are not limited to the terms. These terms are only used to distinguish one component from another. For example, a first component could be termed a second component, and similarly, a second component could be termed a first component, without departing from the scope of exemplary embodiments of the present disclosure.

Moreover, terms denoting directions, such as “front-rear,” “left-right,” “up-down,” etc. are determined with respect to the state of a battery pack being mounted in a vehicle, unless otherwise specified.

A battery pack according to embodiments of the present disclosure has a structure in which battery modules stored and placed within a case are each disposed in independent compartments, whereby, even if a fire occurs in some of the battery modules, the flame is prevented from spreading to battery modules that have not caught fire.

The internal space in the case is, in addition to the battery modules, provided therein with bus bars configured to electrically interconnect the battery modules, and the bus bars may be disposed at a height connected to the components of the battery modules, such as a terminal, forming a power relay assembly (PRA) in a shortest path through longitudinal and transverse members.

The battery pack according to embodiments of the present disclosure is provided with a plurality of compartments, each allowing the battery modules to be individually disposed within the case using the longitudinal and transverse members.

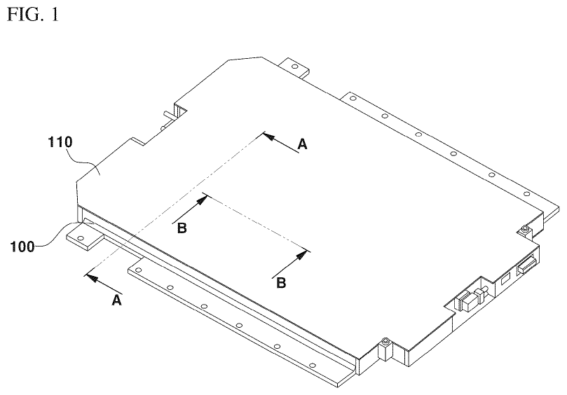

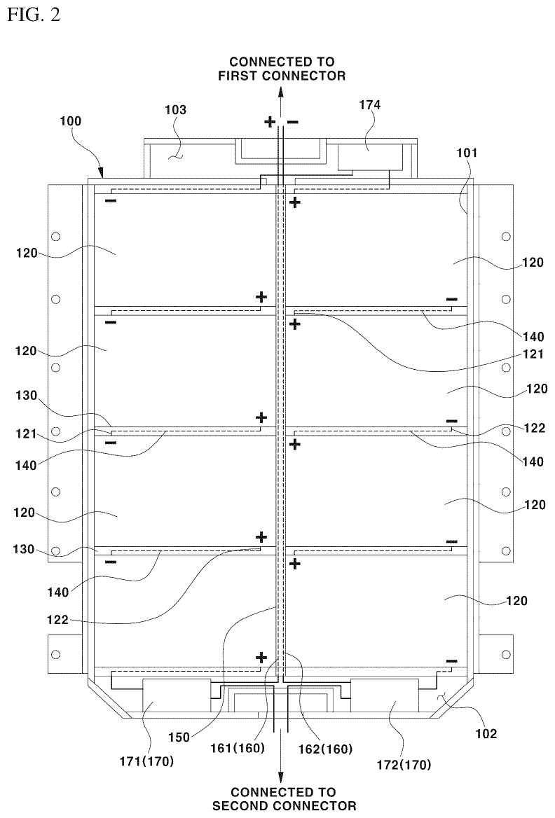

As illustrated in FIG. 1 and FIG. 2, the battery pack includes a case 100 having an internal space in which a plurality of battery modules 120 is placed and stored and a cover 110 configured to open and close the upper end of the case 100.

The case 100 has an internal space with the upper end thereof being open. The internal space includes a main storage space 101 in which the battery modules 120 are stored and a first storage space 102 and a second storage space 103 provided forward and rearward of the main storage space 101, respectively. The first storage space 102 is provided at the front portion of the case 100, and the second storage space 103 is provided at the rear portion of the case 100.

In the main storage space 101, the plurality of battery modules 120 is stored and is arranged in front-rear and left-right directions. According to the embodiment of FIG. 2, the battery modules 120 may be arranged in two rows in a transverse direction and in four rows in a longitudinal direction. Here, the transverse direction may be the width direction of the vehicle in which the battery pack is mounted, and the longitudinal direction may be the front-rear direction of the vehicle in which the battery pack is mounted.

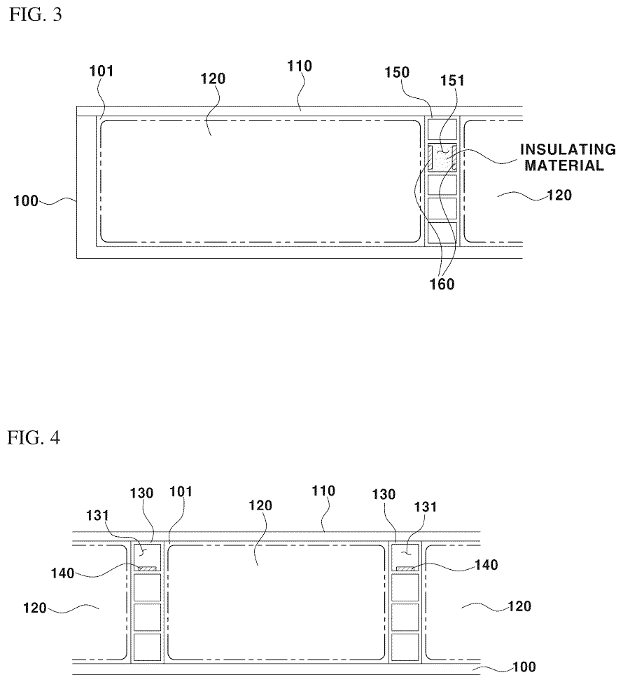

Moreover, the main storage space 101 is provided therein with a plurality of transverse members 130 and one longitudinal member 150. As illustrated in FIG. 3 and FIG. 4, the transverse members 130 and the longitudinal member 150 may be mounted to be fixed to the floor surface of the case 100. The transverse members 130 are arranged to be spaced apart in the longitudinal direction, and the longitudinal member 150 is disposed in the central portion of the main storage space 101 and extends in the front-rear direction.

Between every pair of transverse members 130, provided is one battery module 120. In other words, the transverse members 130 are each disposed between every pair of battery modules 120 disposed in the main storage space 101 and extend in the transverse direction.

Here, the transverse member 130 includes a first end portion airtightly adjacent to the inner side surface of the case 100 and a second end portion airtightly adjacent to the outer side surface of the longitudinal member 150. So as to fix the transverse members 130 at predetermined positions within the case 100, the first end portion of the transverse member 130 may be bonded to the inner side surface of the case 100, and the second end portion of the transverse member 130 may be bonded to the outer side surface of the longitudinal member 150.

Furthermore, for electrical connection among the battery modules 120 arranged in the front-rear direction, the transverse members 130 are each provided with one transverse bus bar 140. The battery modules 120 arranged in the front-rear direction within the case 100 may be connected in series through the transverse bus bars 140. The transverse bus bars 140 are each stored and placed in the internal spaces of the transverse members 130 and extend in the transverse direction.

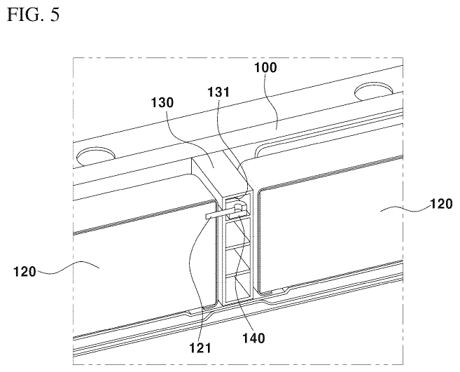

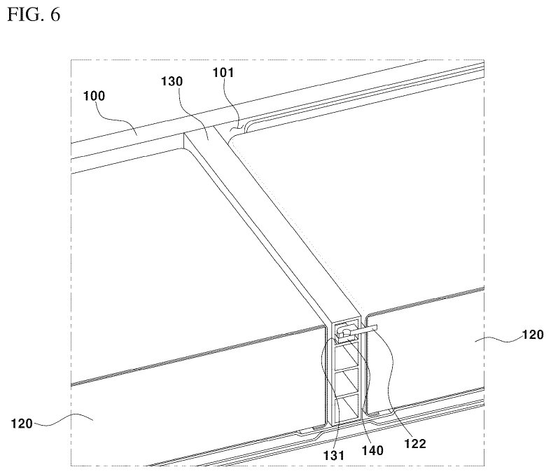

In order to adjust the height and position of the transverse bus bar 140, the internal space in the transverse member 130 may have a structure divided into multiple layers, as illustrated in FIGS. 5 and 6. Specifically, the internal space in the transverse member 130 may include a plurality of storage spaces 131 arranged vertically. So as to match the height of terminals 121 and 122 provided in the battery module 120, the transverse bus bar 140 may be placed in any one of the plurality of storage spaces 131.

The battery modules 120 each include a first terminal 121 having one polarity of either of a negative electrode or a positive electrode and a second terminal 122 having the other polarity. Specifically, the battery module 120 includes the first terminal 121 connected to the transverse bus bar 140 disposed at the front of the battery module 120 and the second terminal 122 connected to the transverse bus bar 140 disposed at the rear of the battery module 120.

Referring to FIG. 2, the first terminal 121 may be provided at the front left side of the battery module 120, and the second terminal 122 may be provided at the rear right side of the battery module 120. With this structure, the first terminal 121 may be connected to the left side of the transverse bus bar 140 disposed at the front of the battery module 120 in the shortest distance, and the second terminal 122 may be connected to the right side of the transverse bus bar 140 disposed at the rear of the battery module 120 in the shortest distance. Because the first terminal 121 and the second terminal 122 may be connected to the transverse bus bar 140, extending left and right, at any position of the transverse bus bar 140, the first terminal 121 and the second terminal 122 may form a shortest power line to be connected to the transverse bus bar 140.

The terminals 121 and 122 of the battery modules 120 are connected to a transverse bus bar 140 adjacent to or closest to the battery modules 120. Here, the terminals 121 and 122 may pass through a side portion of the transverse member 130 so as to be connected to the transverse bus bar 140. The portion of the transverse member 130 passed through the transverse bus bar 140 may be sealed using a sealer or an insulating material.

Moreover, because the transverse bus bar 140 is disposed in the storage space 131 in the transverse member 130, the transverse bus bar 140 may be hidden by being disposed within the transverse member 130 and may be electrically connected to the battery module 120 without a separate mount.

Referring to FIG. 2, so as to electrically interconnect the battery modules 120 arranged in the left-right direction in the main storage space 101 in the case 100, a pair of battery modules 120 disposed at the forefront are connected to each other through a fuse 174. The fuse 174 may be disposed in the first storage space 102. The pair of battery modules 120 disposed at the forefront may be referred to as a front battery module.

Meanwhile, the longitudinal member 150 extends in the front-rear direction by being disposed between the battery modules 120 arranged in the left-right direction stored in the case 100. The longitudinal member 150 extends in the front-rear direction, thereby completely dividing the main storage space 101 in the case 100 into left and right portions.

The longitudinal member 150 is provided therein with a pair of longitudinal bus bars 160. The pair of longitudinal bus bars 160 is connected to a pair of power relay assemblies (PRAs) 170. The pair of PRAs 170 is disposed at either the front or the rear of the battery modules 120. At the other of the front or the rear of the battery modules 120, disposed is a first connector (see FIG. 2). The first connector may be disposed opposite the PRAs 170 with respect to the longitudinal bus bar 160.

So as to connect the PRAs 170 to the first connector, the pair of longitudinal bus bars 160 is disposed to extend in the front-rear direction in the main storage space 101 by being inserted into the longitudinal member 150.

As illustrated in FIG. 2, a first longitudinal bus bar 161 is connected in series to a first PRA 171, and a second longitudinal bus bar 162 is connected in series to a second PRA 172. The first PRA 171 is connected to a first terminal of the second connector (see FIG. 2), and the second PRA 172 is connected to a second terminal of the second connector. The first terminal of the second connector has either a positive or negative polarity, and the second terminal of the second connector has a polarity opposite to that of the first terminal. The second connector may be disposed at the opposite side of the first connector with respect to the longitudinal bus bar 160. In other words, the pair of PRAs 170 is connected to the second connector disposed opposite the first connector with respect to the pair of longitudinal bus bars 160.

The first PRA 171 is, in addition to a first power line connected to the first terminal of the second connector, provided with a second power line connected to the first longitudinal bus bar 161. The second PRA 172 is, in addition to a third power line connected to the second terminal of the second connector, provided with a fourth power line connected to the second longitudinal bus bar 162. In other words, the first terminal of the second connector and the first longitudinal bus bar 161 are connected in parallel to the first PRA 171, and the second terminal of the second connector and the second longitudinal bus bar 162 are connected in parallel to the second PRA 172.

The first connector and the second connector may be general electric connectors used for electrical connection and may discharge power from the battery pack to an external device (or an external component) or charge power from an external device (or an external component) to the battery pack. The power of the battery pack is the power of the battery modules 120 connected in series through the transverse bus bars 140 and the fuse 174. The pair of PRAs 170 is connected to the battery modules 120 in series.

The PRA 170 may be configured to regulate the electric circuit for discharging or charging the battery modules 120. The PRA 170 may be connected to a motor for driving a vehicle through, for example, a connector and an inverter. The fuse 174 may block the flow of overcurrent that causes damage to the battery pack.

FIG. 2 illustrates the wiring structure for electrical connection in the battery pack using dotted lines and solid lines. Specifically, in order to show the electrical connection among the components of the battery pack, the transverse bus bars 140, the longitudinal bus bars 160 and the terminals 121, 122 of the battery modules 120 are indicated with dotted lines, and the other power lines are indicated with solid lines. Moreover, the +sign and the −sign on the battery module 120 indicate the polarity of the terminals 121, 122 of the battery module 120.

So as to store the pair of longitudinal bus bars 160, the longitudinal member 150 includes an internal space extending in the front-rear direction. In other words, the pair of longitudinal bus bars 160 is placed and stored in the internal space of the longitudinal member 150 and extends in the front-rear direction.

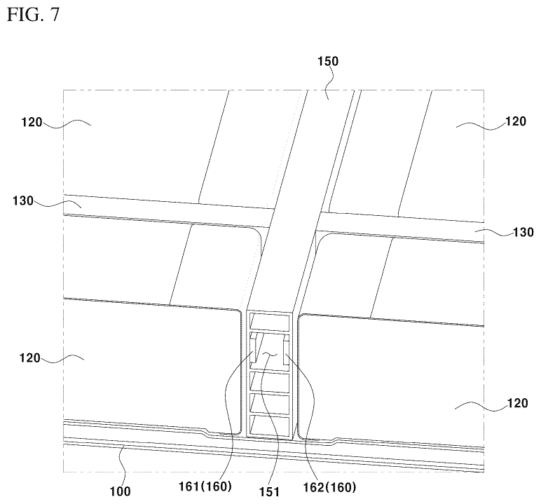

In order to adjust the height and position of the longitudinal bus bars 160, the internal space in the longitudinal member 150 may have a structure divided into multiple layers, as illustrated in FIG. 7. Specifically, the internal space in the longitudinal member 150 may include a plurality of storage spaces 151 arranged vertically. So as to facilitate connection to the components disposed in the first storage space 102 and the second storage space 103 in the case 100, the longitudinal bus bar 160 may be placed in any one of the plurality of storage spaces 151.

The pair of longitudinal bus bars 160 may be disposed in one storage space among the storage spaces 151 in the longitudinal member 150. Here, the longitudinal bus bars 160 are disposed to be spaced apart left and right from each other, and so as to insulate the longitudinal bus bars 160 from each other, an insulating material (see FIG. 3) is filled in the storage space 151 in which the longitudinal bus bars 160 are stored.

Furthermore, the longitudinal member 150 includes a first end portion extending up to the position of the transverse member 130 disposed at the forefront among the plurality of transverse members 130 and a second end portion extending up to the position of the transverse member 130 disposed at the rear end among the plurality of transverse members 130.

When the PRAs 170 are placed at the rear portion of the battery pack or a separate connector is added for four-wheel drive of the vehicle, the longitudinal bus bars 160 extending in the front-rear direction as described above are needed for electrical connection. In other words, so as to electrically connect a first component disposed forward of the battery modules 120 to a second component disposed rearward of the battery modules 120, the longitudinal bus bars 160 are disposed to extend in the front-rear direction in the main storage space 101. The longitudinal bus bars 160 elongated forward and rearward in the main storage space 101 are disposed in the storage space 151 in the longitudinal member 150, securing electrical safety.

Moreover, when the battery pack according to embodiments of the present disclosure is applied to a vehicle (e.g., a two-wheel drive vehicle) that does not need a separate connector (i.e., the second connector), the PRAs 170 may not be connected to the second connector. When the battery pack is not connected to the second connector, there is no need of a separate longitudinal bus bar, and thus, the longitudinal bus bar 160 may not be provided within the longitudinal member 150. Therefore, in the case of the battery pack according to another embodiment of the present disclosure, the longitudinal bus bar 160 may not be provided within the longitudinal member 150.

As illustrated in FIG. 3 and FIG. 4, the upper ends (i.e., upper surfaces) of the transverse members 130 and the longitudinal member 150 have the same height as the upper end of the case 100. In other words, the upper ends of the transverse members 130 and the upper end of the longitudinal member 150 are at the same height as the upper end of the case 100. Because the upper ends of the transverse members 130 and the upper end of the longitudinal member 150 are at the same height as the upper end of the case 100, the sealing performance of the battery pack is enhanced.

Therefore, when the cover 110 is stacked to be mounted on the upper end of the case 100, the upper ends of the transverse members 130 and the upper end of the longitudinal member 150 may be brought into airtight contact with the bottom surface of the cover 110. Here, the upper ends of the transverse members 130, the upper end of the longitudinal member 150, and the upper end of the case 100 may be airtightly attached to the bottom surface of the cover 110 using a sealer. The sealer may be applied to the upper ends of the transverse members 130, the upper end of the longitudinal member 150, and the upper end of the case 100, and the bottom of the cover 110 may be laminated on these upper ends. The upper ends of the transverse members 130, the upper end of the longitudinal member 150, and the upper end of the case 100 may have a planar structure to be tightly brought into contact with the bottom surface of the cover 110.

Here, the cover 110 closes the upper ends of the main storage space 101, the first storage space 102, and the second storage space 103 in the case 100, and at the same time, provides a plurality of compartments in the main storage space 101, wherein each of the compartments is sealed for a battery module disposed therein. Each of the compartments is a space surrounded and sealed by the case 100 and cover 110, as well as the transverse members 130 and the longitudinal member 150. Because the battery modules 120 are each disposed in an independent compartment as described above, even if some of the battery modules 120 within the case 100 are on fire, the flame may be prevented from spreading to battery modules that have not caught fire.

Moreover, according to embodiments of the present disclosure, the transverse bus bars 140 and the longitudinal bus bars 160 are disposed in the storage spaces 131 and 151 in the transverse members 130 and longitudinal member 150, respectively, and thus are not exposed outside. Here, the longitudinal bus bars 160 and the transverse bus bars 140 are entirely surrounded and hidden by the longitudinal member 150 and the transverse members 130, ensuring electrical safety.

Accordingly, the risk of the bus bar being short-circuited in the event of vibration or impact on the battery pack or thermal runaway of the battery module is eliminated, preventing a fire due to the short-circuit of the bus bar.

Furthermore, the assembly structure and wiring structure of the battery pack are simplified, increasing productivity. The transverse bus bar 140 may be integrated with the transverse member 130, and the longitudinal bus bar 160 may be integrated with the longitudinal member 150. The battery pack including the transverse bus bar 140, the transverse member 130, the longitudinal bus bar 160, and the longitudinal member 150 may be commonly used to thereby enhance productivity.

As is apparent from the above description, embodiments of the present disclosure provide the following effects.

First, the battery modules in the case are independently disposed in a sealed space (i.e., a compartment) surrounded by the longitudinal member, the transverse members, and the cover, and thus, even if thermal runaway occurs in some battery modules, the flame may be prevented from spreading to other battery modules where thermal runaway has not occurred.

Second, the upper ends of the longitudinal member and the transverse member are at the same height as the upper end of the case, whereby, when coupling the cover to the case, the upper ends of the case, the longitudinal member, and the transverse member are brought into close contact with the bottom surface of the cover, improving the sealing performance and sealing quality of the battery pack.

Third, a pair of longitudinal bus bars is stored in an internal space in the longitudinal member where an insulating material is filled, eliminating the risk of short circuit in the event of vibration or collision of the vehicle or thermal runaway of the battery pack.

Fourth, because the terminal of the battery module is connected to the transverse bus bar at the optimal position, the power line for connecting the battery modules within the case to the second component and first component may form the shortest path, simplifying the wiring structure and assembly structure of the battery pack, thereby increasing productivity.

Effects of embodiments of the present disclosure are not limited to what has been described above, and other effects not mentioned herein will be clearly recognized by those skilled in the art based on the above description.

Terms or words used in this specification and claims described below should not be construed as being limited to conventional or dictionary meanings. In addition, the scope of the present disclosure is not limited to the above-described embodiments, and various modifications and improvements by those skilled in the art using the basic concepts of embodiments of the present disclosure as defined in the claims below will also be included in the scope of the present disclosure.

What is claimed is:

1. A battery pack comprising:
a case having an internal space in which a plurality of battery modules arranged in front-rear and left-right directions is placed;
a plurality of transverse members disposed between the battery modules arranged in the front-rear direction among the plurality of battery modules;
a plurality of transverse bus bars disposed in internal spaces of the transverse members and configured to connect the battery modules arranged in the front-rear direction;
a longitudinal member disposed between the battery modules arranged in the left-right direction among the plurality of battery modules and extending in the front-rear direction; and
a pair of longitudinal bus bars disposed in an internal space of the longitudinal member, extending in the front-rear direction, and configured to connect a first component disposed forward of the battery modules to a second component disposed rearward of the battery modules.

2. The battery pack of claim 1, further comprising a cover disposed at an upper end of the case, wherein the cover covers an upper end of the case while being in close contact with the upper end of the case, an upper end of the longitudinal member, and upper ends of the transverse members.

3. The battery pack of claim 2, wherein the upper end of the case, the upper end of the longitudinal member, and the upper ends of the transverse members are attached to a bottom surface of the cover using a sealer.

4. The battery pack of claim 1, wherein an upper end of the longitudinal member and upper ends of the transverse members are disposed at a same height as an upper end of the case.

5. The battery pack of claim 1, wherein the plurality of transverse members comprises a first end portion adjacent to the longitudinal member and a second end portion adjacent to the case.

6. The battery pack of claim 1, wherein the longitudinal member comprises:
a first end portion extending up to a position of a first transverse member disposed at a forwardmost position among the plurality of transverse members; and
a second end portion extending up to a position of a second transverse member disposed at a rearmost position among the plurality of transverse members.

7. The battery pack of claim 1, wherein each battery module of the plurality of battery modules has a first terminal connected to a first transverse bus bar disposed at a front of the battery module and a second terminal connected to a second transverse bus bar disposed at a rear of the battery module.

8. The battery pack of claim 1, wherein the longitudinal member has a storage space in which the pair of longitudinal bus bars is disposed, and wherein the storage space is filled with an insulating material.

9. The battery pack of claim 1, wherein each transverse member of the plurality of transverse members has a storage space in which one transverse bus bar is disposed.

10. The battery pack of claim 1, wherein:
the first component comprises a pair of power relay assemblies (PRAs) and the second component comprises a first connector; and
the pair of PRAs is connected to a second connector disposed opposite the first connector based on the pair of longitudinal bus bars.

11. A battery pack comprising:
a case having an internal space in which a plurality of battery modules arranged in front-rear and left-right directions is placed;
a plurality of transverse members disposed between the battery modules arranged in the front-rear direction among the plurality of battery modules;
a plurality of transverse bus bars disposed in internal spaces of the transverse members and configured to connect the battery modules arranged in the front-rear direction;
a longitudinal member disposed between the battery modules arranged in the left-right direction among the plurality of battery modules and extending in the front-rear direction; and
a cover configured to cover an upper end of the case while being in close contact with the upper end of the case, an upper end of the longitudinal member, and upper ends of the transverse members.

12. The battery pack of claim 11, wherein the upper end of the longitudinal member and the upper ends of the transverse members are disposed at a same height as the upper end of the case.

13. The battery pack of claim 11, wherein the plurality of transverse members comprises a first end portion adjacent to the longitudinal member and a second end portion adjacent to the case.

14. The battery pack of claim 11, wherein the longitudinal member comprises:
a first end portion extending up to a position of a first transverse member disposed at a forwardmost position among the plurality of transverse members; and
a second end portion extending up to a position of a second transverse member disposed at a rearmost position among the plurality of transverse members.

15. The battery pack of claim 11, wherein each battery module of the plurality of battery modules has a first terminal connected to a first transverse bus bar disposed at a front of the battery module and a second terminal connected to a second transverse bus bar disposed at a rear of the battery module.

16. The battery pack of claim 11, wherein each transverse member of the plurality of transverse members has a storage space in which one transverse bus bar is disposed.

17. The battery pack of claim 11, wherein the upper end of the case, the upper end of the longitudinal member, and the upper ends of the transverse members are attached to a bottom surface of the cover using a sealer.

18. The battery pack of claim 11, further comprising a pair of longitudinal bus bars disposed in an internal space of the longitudinal member, extending in the front-rear direction, and configured to connect a first component disposed forward of the battery modules to a second component disposed rearward of the battery modules.

19. The battery pack of claim 18, wherein the longitudinal member has a storage space in which the pair of longitudinal bus bars is disposed, and wherein the storage space is filled with an insulating material.

20. The battery pack of claim 18, wherein:
the first component comprises a pair of power relay assemblies (PRAs) and the second component comprises a first connector; and
the pair of PRAs is connected to a second connector disposed opposite the first connector based on the pair of longitudinal bus bars.
